(19) United States
(12) Patent Application Publication
(10) Pub. No.: US 2012/0179968 A1
(43) Pub. Date: Jul. 12, 2012

(54) DIGITAL SIGNAGE SYSTEM AND METHOD

(76) Inventors: Steven Gregory Madnick, Southampton, PA (US); Peter Scott Madnick, Dresher, PA (US)

(21) Appl. No.: 13/345,088

(22) Filed: Jan. 6, 2012

Related U.S. Application Data
(60) Provisional application No. 61/430,396, filed on Jan. 6, 2011.

(51) Int. Cl. G06F 3/00; G06F 3/16; G06F 3/048

(52) U.S. Cl. 715/719; 715/781; 715/727; 715/777

(57) ABSTRACT

A digital signage system comprising: a client device associated with a display device and linked to a server through the worldwide network, and having a user input device, the client device being configured to perform the following functions: (a) receiving a signal from the server, the signal corresponding to signage; (b) displaying the signage based on the signal; (c) displaying a window to configure the signage, the window being displayed in front of the signage, the window providing inputs to select content and/or format of the signage; (d) transmitting a selection of the content and/or format to the server when the selection is entered by a user; (e) receiving an updated signal from the server corresponding to the signage modified according to the selection; and (f) displaying the modified signage while the window is displayed, thereby providing the user with near real-time feedback of changes made to the signage.

### REFERENCE TO RELATED CASE

This application claims priority to U.S. Provisional Application No. 61/430,396, filed Jan. 6, 2011, hereby incorporated by reference in its entirety.

### FIELD OF INVENTION

The present invention relates generally to digital signage, and, more specifically, to a system and method of displaying and editing digital signage.

### BACKGROUND OF INVENTION

Digital signage has become ubiquitous in commerce and an indispensable tool for marketing and informing the public. Digital signage is a form of electronic display that shows information, advertising and other messages. Digital signs (such as LCD, LED, plasma displays, or projected images) can be found in public and private environments, such as retail stores and corporate buildings, on billboards, in waiting rooms, and lining sports arenas—essentially any place where people may look.

Digital signage has significant advantages over static signs in that the message can be changed readily and is delivered using different mediums, including video, still images, audio and text. The format of the signs can also adapt to the content and the audience. Some digital signs are even interactive.

Traditionally, digital signage displays were controlled using dedicated computers loaded with proprietary software programs. More recently, however, digital signs are being controlled through client/server networks. The client device is typically a media player, which is connected to the display through a cable or it may be integrated with the display. The client is connected to the server typically over a network, such as the Internet. The server is maintained/operated remotely, and functions to push content down to the client and typically other clients on the network. “Content”, in the context of digital signage, is the name used to describe anything designed and displayed on screens, including text, images, animations, video, audio, and interactivity.

Content design, like the design for static signage, has traditionally been provided through 3rd party specialists or, for larger users, a relatively sophisticated in-house resource. In many digital signage applications, content is regularly updated to ensure that the messages being displayed are relevant and interesting. Because some content changes quickly, for example, stock prices, news and weather reports, it is often provided by 3rd party content providers such as Canadian Press, Thomson Reuters, or AHN. Larger users may also use an in-house data source.

Typically, managing a digital display network requires a management server. New content is managed and organized on this server, while the actual content itself is stored and fed to clients from a different server.

Therefore, client/server digital signage networks today tend to be complex, involving a variety of different servers, one to feed the display clients, others to provide content, and yet another to manage content. Each server is often maintained and operated by a different entity. Although such complexity may not be an issue for large, sophisticated users with the requisite technical and financial resources, smaller users tend to lack these resources. Rather, smaller users need to be able to operate and manage their signage in-house, using lay people with little or no technical expertise in digital signage management. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Applicants recognize that programming and modifying content for digital signage is often more effective if performed by the end user rather than by a 3^{rd} party that provides content programming services. By enabling the end user to perform the content modification, significant cost saving can be realized along with increased agility in making changes. End users, such as doctors and retail store owners, however, generally lack expertise in content management. Accordingly, Applicants recognize that the user interface for making the content changes needs to be simple and intuitive. To this end, Applicants have developed a software platform that combines the playback and editing/maintenance functions into one screen, allowing the user to make edits and modifications while seeing them displayed and animated in real time. In this way, Applicants bring the concept of “what you see is what you get” to digital signage management. Therefore, unlike the traditional approach in which content needed to be modified in a separate management server and then transmitted to a feed server for display on the display/client device, the present invention introduces a system in which content is modified at the client device, while the signage is being displayed in real time. Applicants have found that integrating the signage viewing and editing functions makes the content much easier to edit.

To make the user interface even more intuitive, in one embodiment, a single window is provided on a display with the signage running in the background. The window has intuitive inputs or buttons to allow the user to select links from 3^{rd} party content servers (for example, YouTube).

One aspect of the invention is a system for providing digital signal having the capability of editing content while the signage is played in the background. In one embodiment, the digital signage system comprises: (a) a server linked to a worldwide network and having a data store of client information relating to signage; (b) a digital display device for displaying the signage; (c) a client device associated with the display device and linked to the server through the worldwide network, and having a user input device, the client device being configured to perform the following functions: (i) receiving a live feed from the server, the feed providing a signal for the signage; (ii) displaying the signage for a user based on the signal; (iii) displaying a window to configure the signage, the window being in front of the signage, the window providing inputs for the user to select content and/or format of the signage; (iv) transmitting a selection of the content and/or format to the server when it is entered by the user; (v) receiving an updated live feed from the server with the signage modified according to the selection; and (vi) displaying the modified signage immediately after the selection is entered, thereby providing the user with near real-time feedback of changes made to the signage.

Another aspect of the invention is a client device for use in the system described above. In one embodiment, the client device is associated with a display device, is linked to a server through the worldwide network, has a user input device, and is configured to perform the following functions: (i) receiving a live feed from the server, the feed providing a signal for the signage; (ii) displaying the signage for a user based on the signal; (iii) displaying a window to configure the signage, the window being in front of the signage, the window providing inputs for the user to select content and/or format of the signage; (iv) transmitting a selection of the content and/or format to the server when it is entered by the user; (v) receiving an updated live feed from the server with the signage modified according to the selection; and (vi) displaying the modified signage immediately after the selection is entered, thereby providing the user with near real-time feedback of changes made to the signage.

Another aspect of the invention is a graphical user interface for facilitating editing of signage while the signage is displayed in the background. In one embodiment, the GUI causing the simultaneous display of signage and at least one editing window, the GUI being configured to perform the following steps: (a) generating a display representing signage; (b) displaying a window to configure the signage, the window being in front of the signage, the window providing inputs for the user to select content and/or format of the signage; (c) receiving a selection of the content and/or format from the user and transmitting it to the server; and (d) displaying the modified signage immediately after the selection is transmitted, thereby providing the user with near real-time feedback of changes made to the signage.

Yet another aspect of the invention is a method of editing digital signage while the signage is displayed. In one embodiment, the method comprises: (a) generating a display of the signage; (b) displaying a window to configure the signage, the window being in front of the signage such that the signage is visible behind the window, the window providing inputs for the user to select content and/or format of the signage; (c) receiving a selection of the content and/or format from the user and transmitting the selection to a server; and (d) immediately after the selection is transmitted to the server, displaying the modified signage from the server behind the window, thereby providing the user with near real-time feedback of changes made to the signage.

Still another aspect of the invention is a computer-readable medium containing instructions for having a client device perform the method above. In one embodiment, the computer-readable medium comprises instructions for configuring a client device to perform the following process steps: (a) generating a display of signage; (b) displaying a window to configure the signage, the window being in front of the signage such that the signage is visible behind the window, the window providing inputs for the user to select content and/or format of the signage; (c) receiving a selection of the content and/or format from the user and transmitting the selection to a server; and (d) immediately after the selection is transmitted to the server, displaying the modified signage from the server behind the window, thereby providing the user with near real-time feedback of changes made to the signage.

### BRIEF DESCRIPTION OF FIGURES

FIG. 1.1-1.48 are screen shots of the user interface of the present invention during the editing process.

FIG. 2 is a schematic of the system of the present invention.

FIG. 3 is a flow chart of the edit process of the present invention.

### DETAILED DESCRIPTION

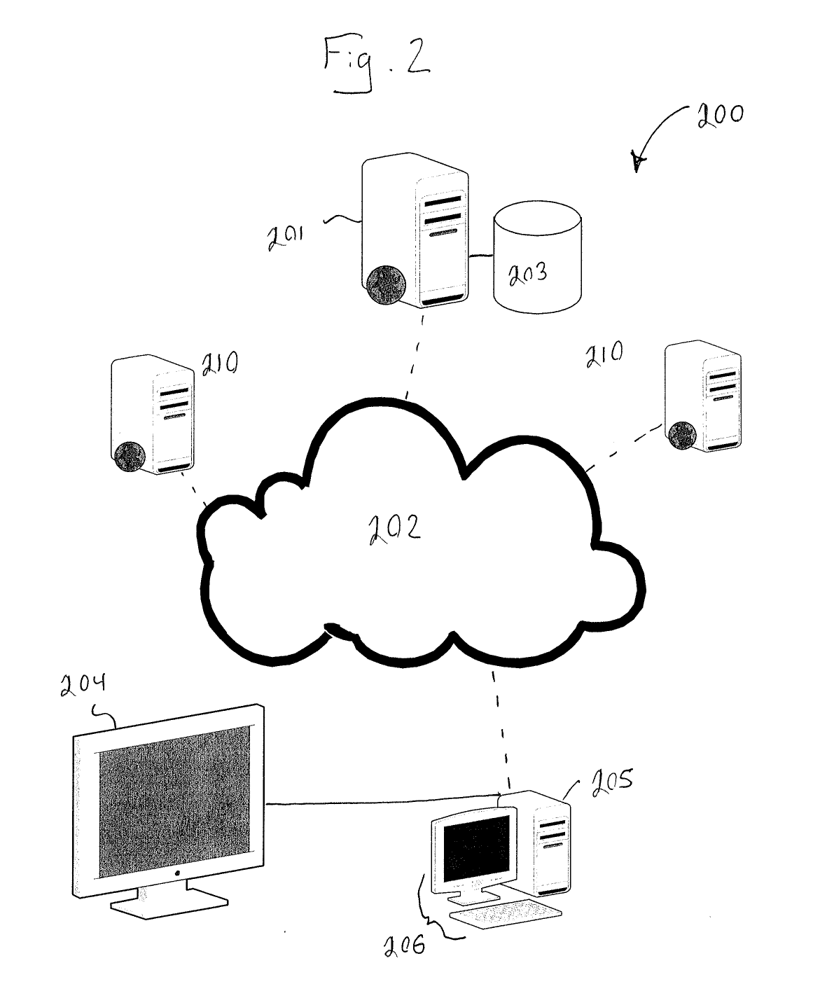

Referring to FIG. 2, an embodiment of the system 200 of the present invention is shown. The digital signage system comprises: (a) a server 201 linked to a worldwide network 202, which optionally is linked to a number of content servers 210, and having a data store 203 of client information relating to signage; (b) a digital display 204 device for displaying the signage; (c) a client device 205 associated with the display device 204 and linked to the server 201 through the worldwide network 202, and having a user input device 206, the client device 205 being configured with digital signage software to perform the following functions: (i) receiving a live feed from the server 201, the feed providing a signal for the signage; (ii) displaying the signage for a user based on the signal; (iii) displaying a window to configure the signage, the window being in front of the signage, the window providing inputs for the user to select content and/or format of the signage; (iv) transmitting a selection of the content and/or format to the server 201 when it is entered by the user; (v) receiving an updated live feed from the server 201 with the signage modified according to the selection; and (vi) displaying the modified signage immediately after the selection is entered, thereby providing the user with near real-time feedback of changes made to the signage.

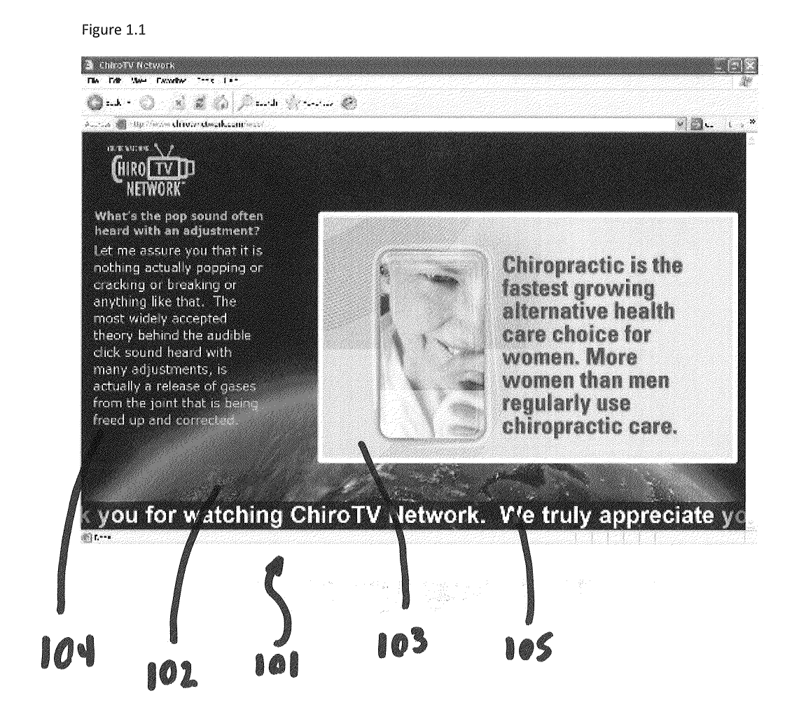

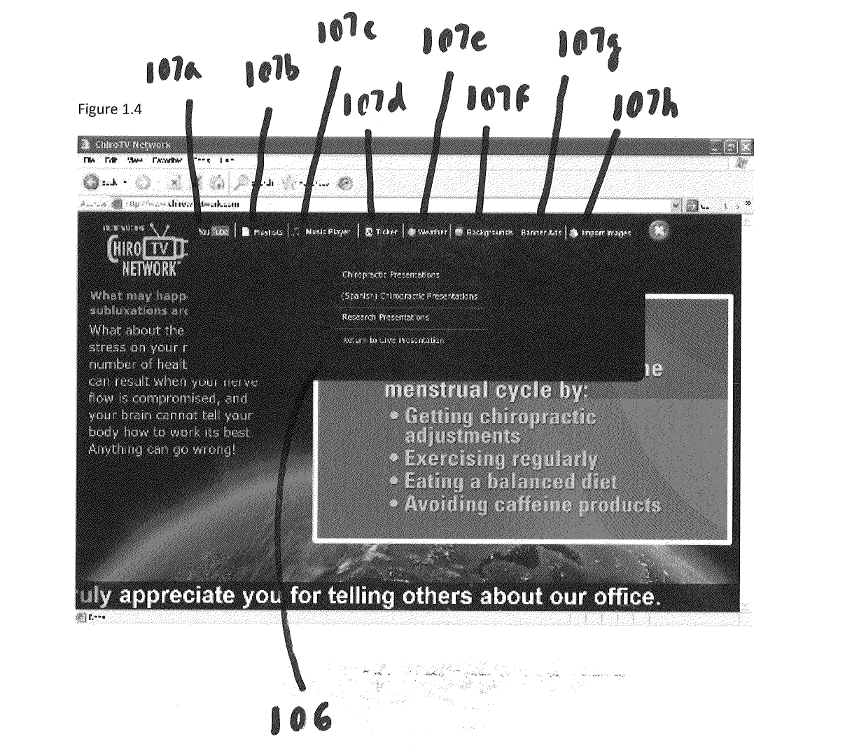

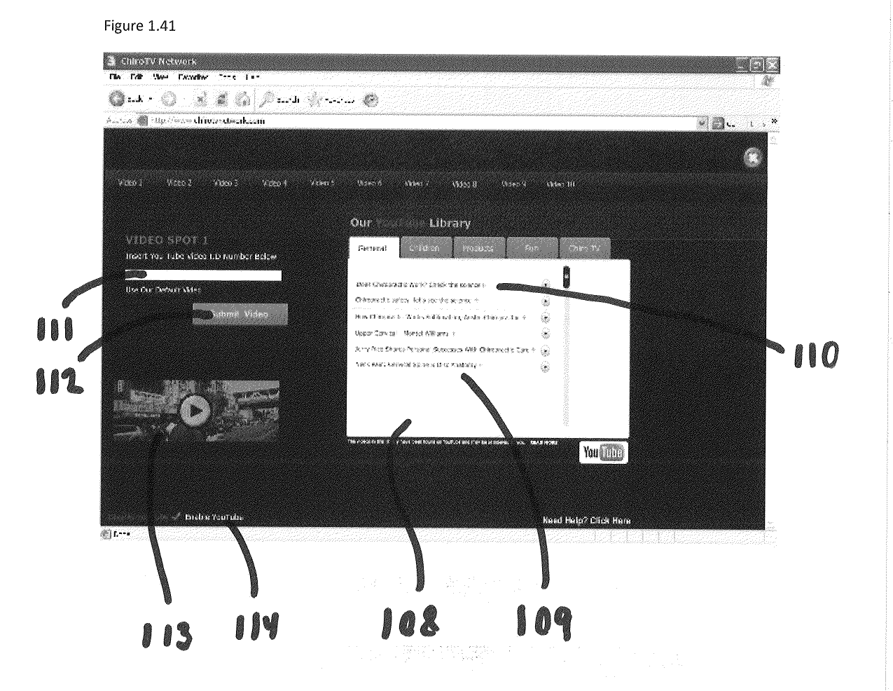

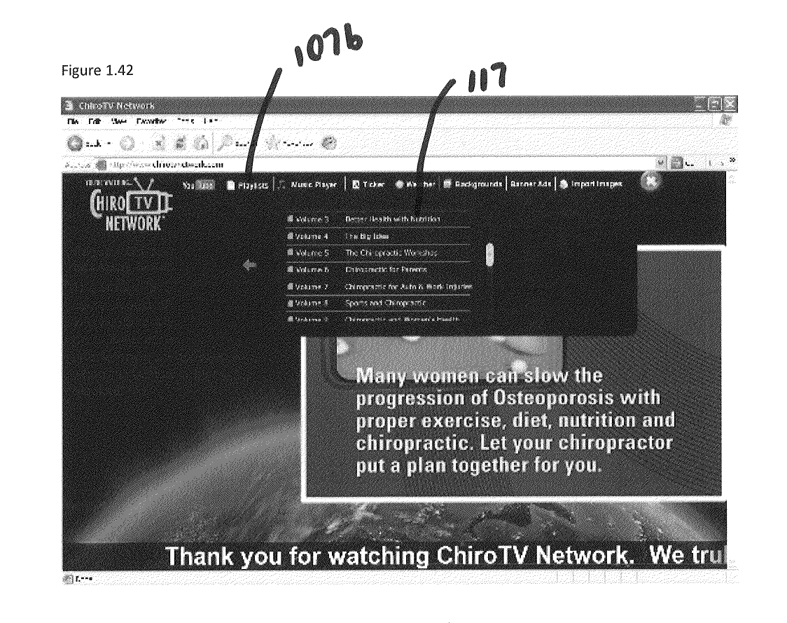

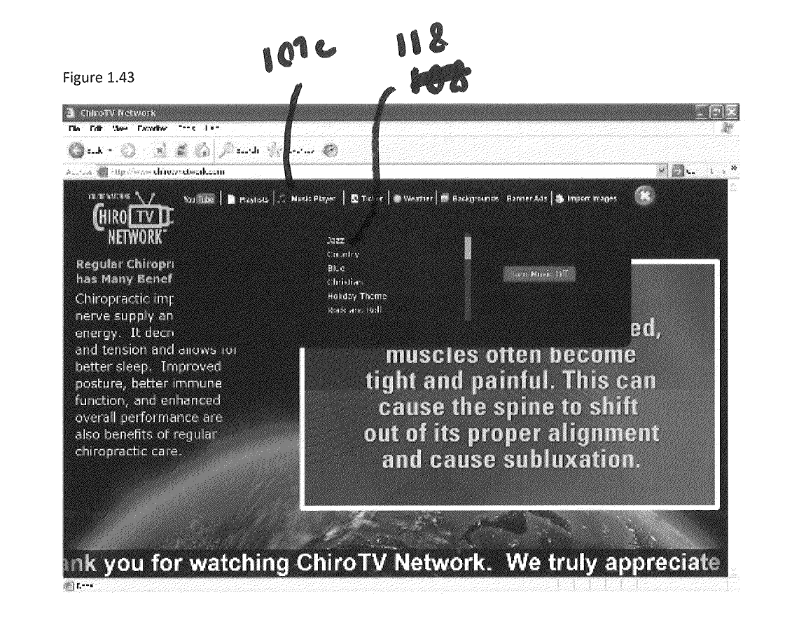

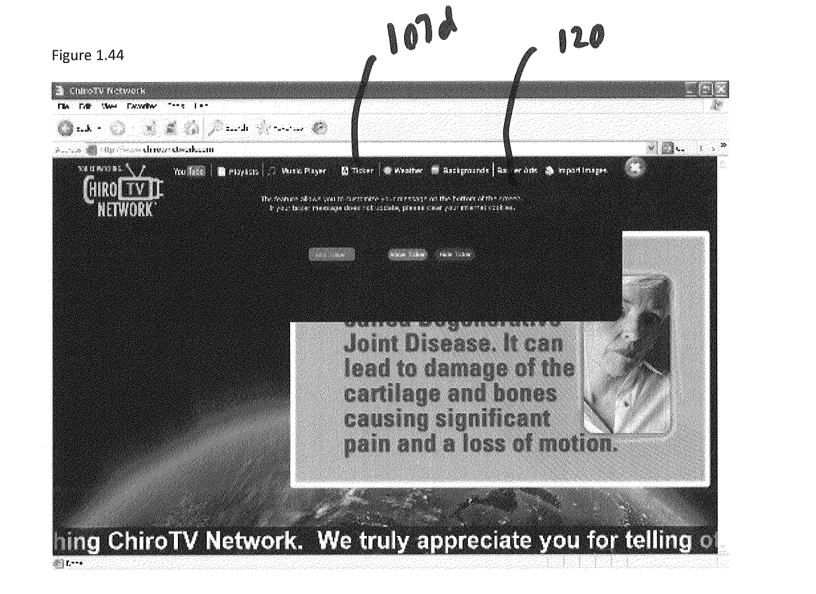

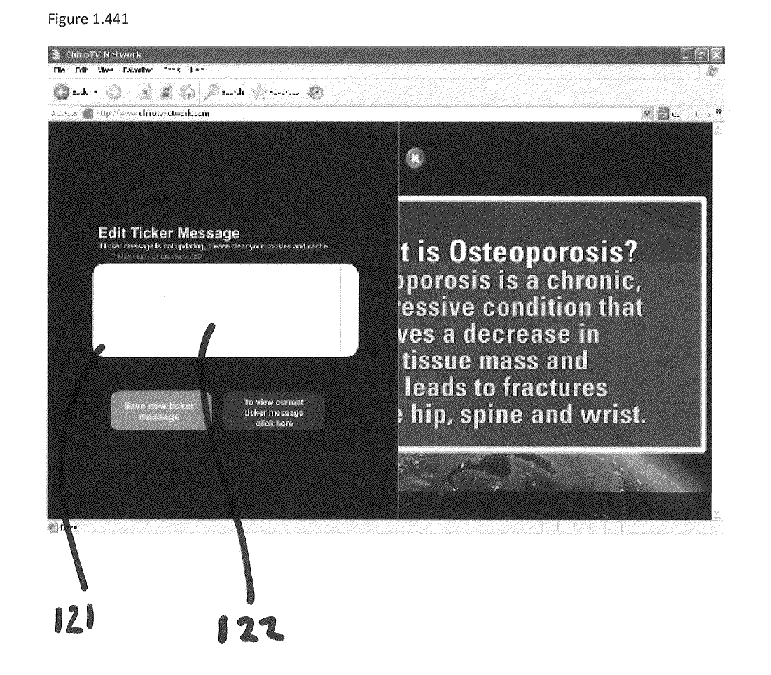

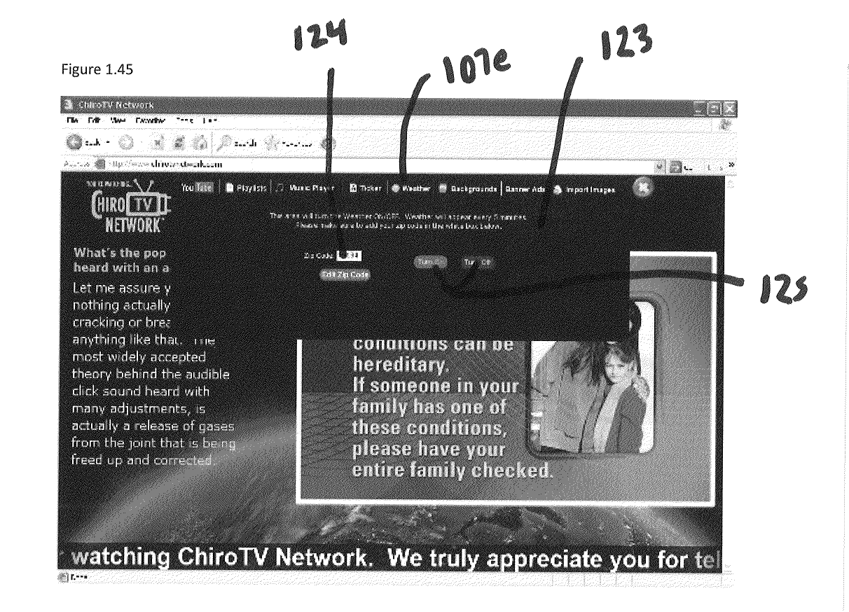

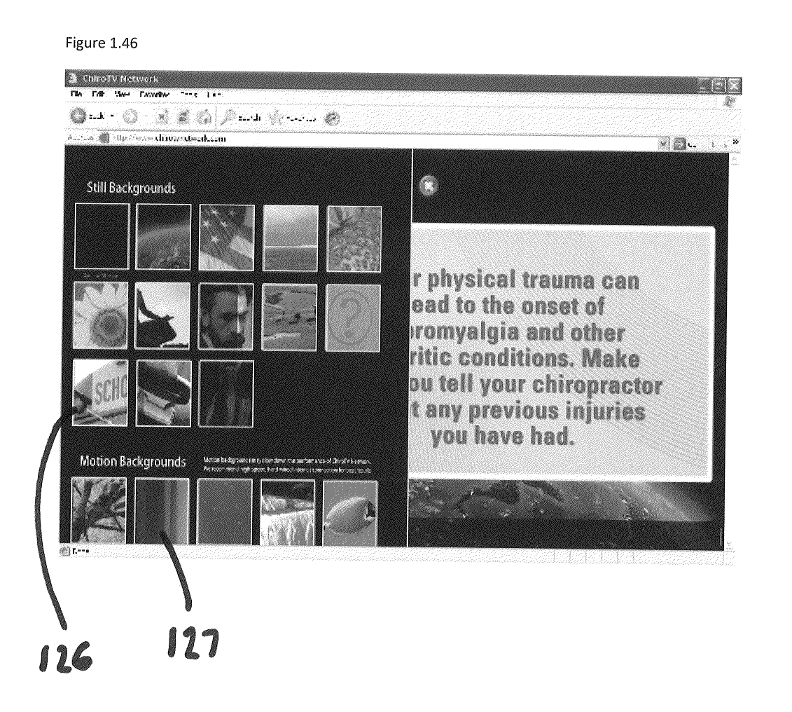

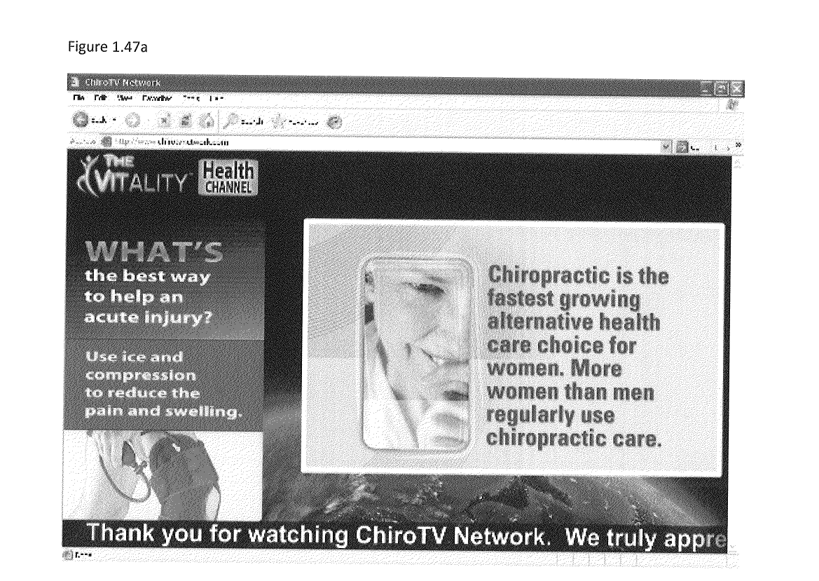

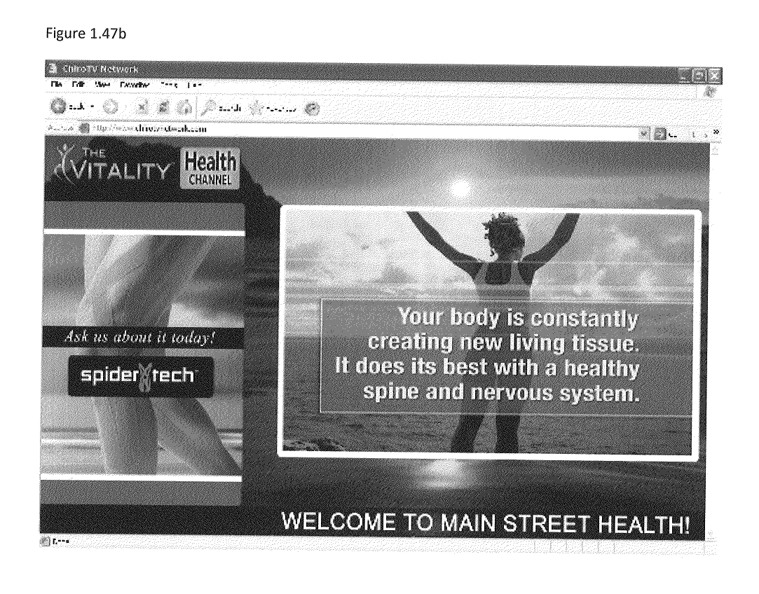

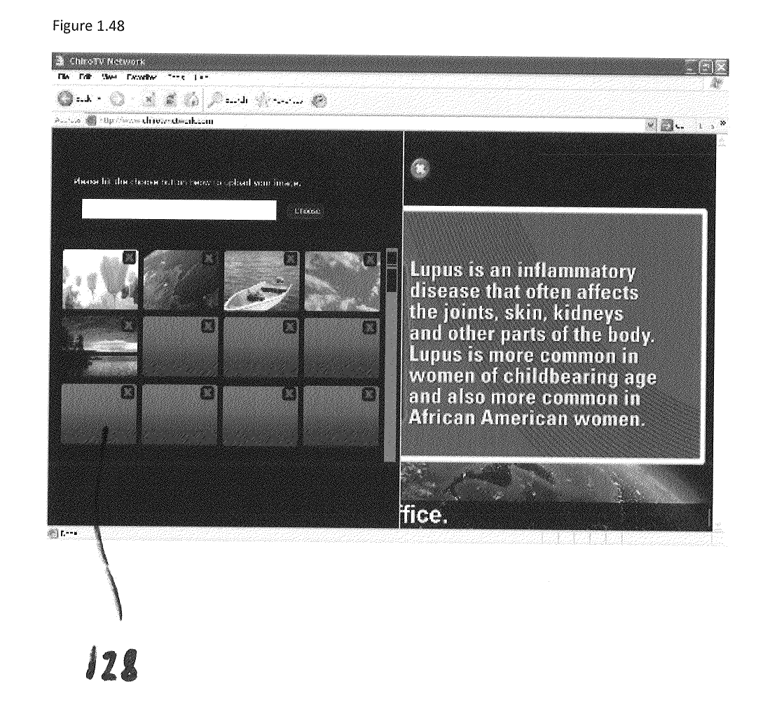

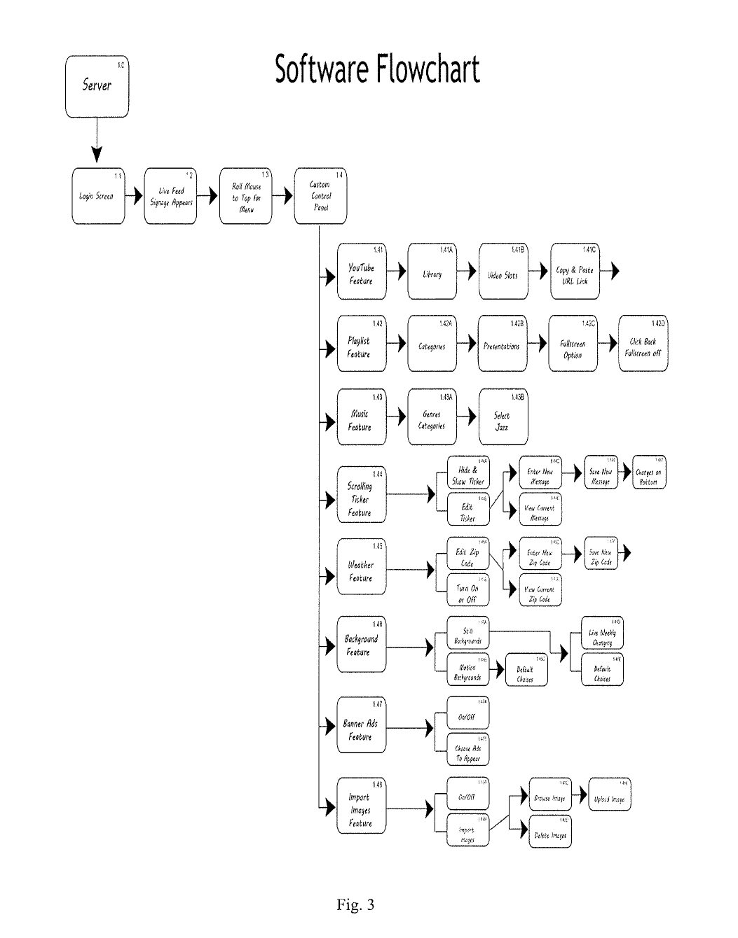

Referring to FIGS. 1.1-1.47 and to the flow chart of FIG. 3, one embodiment of the graphical user interface (GUI) and user interaction is provided. It should be appreciated, however, that this is provided for illustrative purposes and other embodiments of the system and GUI are possible within the scope of the invention. As mentioned above, the digital signage software is designed to give the end user the ability to easily customize his or her display by adding personal touches and content that applies to their business. There are several ways for the end user to customize the display, including changing the playlists, videos, scrolling ticker, music, weather, and even the theme and background of the display. The display is designed to help businesses educate, promote, and entertain their clients while waiting for the particular service to be rendered.

In one embodiment, the process begins with the server 201 (See FIG. 2) in Step 1.0. As mentioned above, it is configured to push content through to digital screens 204 in or more locations. In one embodiment, once a user logs in to the client device using the user interface 206 in Step 1.1, and in Step 1.2, he will immediately see the content begin to stream on the interface 206 as shown in the screenshot 201 of FIG. 1.1. In this particular embodiment, there are four regions of the screen including the Background Image 202, the Main Presentation 203, the Side Text/Banner Ad Spot 204, and the Scrolling Ticker Messenger 205 on the bottom.

To modify this content, the user rolls the mouse up to the top center of the screen shot 101 in Step 1.3, which automatically accesses the “Easy to Use” Custom Control Panel 106 in Step 1.4, as shown in FIG. 1.4. This control panel 106 enables the user to modify content including, for example, adding videos (e.g., YouTube or other Internet-available video content), changing stock content, adding music, adding custom scrolling messages, changing the background image, adding a weather feed, etc. This content can be modified simply by selecting one of the corresponding tabs 107(a)-(h) presented at the top of the control panel 106. The ease of this control panel 106 for the end user is a significant feature and benefit of the system and method of the present invention.

To further illustrate the intuitive nature of the interface, once the user selects, for example, the YouTube tab 107(a) in Step 1.41, as shown in FIG. 1.41, the main YouTube Page 108 is displayed. This page allows the user to import or link up to a number of videos from YouTube (e.g., ten), and have those videos stream in a predetermined order throughout the broadcast. In one embodiment, the software is configured to stream the first YouTube video full screen on top of the Main Broadcast and when it is finished playing in its entirety, the main broadcast will resume for some predestined time, for example, three minutes until the next video slot plays, and so on. In one embodiment, the main slides in the presentation pause while a video is playing and then resume after the video is finished. This component prevents the content in the main presentation 103 from being missed.

In one embodiment, this main YouTube page has a YouTube Library 109 with an “Easy One Click Link Insertion” feature in Step 1.41A. This is beneficial as many end users are not familiar with YouTube. For example, the average end user may not know how to copy and paste a URL from YouTube into this application. To make this easier, in one embodiment, the software displays a library 109 with different videos 110 found on YouTube that apply to a particular market or industry (for example, chiropractors), so the end user merely has to click on the title of the video and the URL tag line is automatically placed in the text field 111. The user then just submits it with the click of a button 112 and it is inserted into that particular video spot. This “Easy One Click Link Insertion” feature allows any user to add video and use the power of YouTube without having to know much about computers. In one embodiment, the software has a default video that will fill the slots that the end user does not fill.

In one embodiment, another component is added to the YouTube Module, and is referred to as the “YouTube Quick Viewing Feature” in Step 1.41B. This component allows the end user to view the videos in the library in a window 113 before inserting them into the video slots. In one embodiment, it also provides an additional preview player that the end user can use to play the videos that are already in the slot positions. This preview feature allows the end user to preview the videos in their presentation right in our application without going onto the Main YouTube Website.

In one embodiment, once the end user tags the videos into each video spot, he enables the YouTube feature using the button 114 in the lower left so that the videos will start streaming through the presentation (display). In one embodiment, the module remembers the custom settings of the video server such that, for example, YouTube stays enabled once the end user logged off and then logged back on.

Referring to FIG. 1.42 and Step 1.42, the next module on the Custom Control Panel 108 in this embodiment is the Playlist tab 107(b). This component of the application offers many different built in slide presentations (Premade Content) 117 that run in the main presentation area 103 of the display. The end user can pick any of the presentations 117 he wants to play and change it anytime with the click of a button. In one embodiment, the software also allows the end user to Full screen the Playlist so that it takes over the entire screen. If the user engages full screen mode, in one embodiment, an “Easy One Click Back” feature is offered that will take him back to the default display view.

Referring the FIG. 1.43 and Step 1.43, the next customizable feature (module) the end user can add to their display in this embodiment is a Music Component corresponding to tab 107(c). This allows the user to turn on or off music that is intended to play along with the presentation. In one embodiment, the software is programmed to provide a list of different genres 118 that the user can choose from including Jazz, New age, Holiday, etc. in Step 1.43A. Each genre selection has several tracks included that play through in Step 1.43B. In one embodiment, the software is programmed to avoid the situation in which music from both this module and the video module (e.g. YouTube) would play simultaneously, making the display annoying. To avoid this problem, the software is configured to mute the music feature if a video with music was streaming.

Referring the FIG. 1.44 and Step 1.44, in this embodiment, the Ticker module window 120 is opened by selecting tab 107(d). The end user can enter a Custom Scrolling Ticker Message that will constantly run the bottom of the screen. Initially, the user will have the options to show or hide the ticker or to edit the ticker in Steps 1.44A, 144B. Referring the FIG. 1.441, when the user clicks on Edit Ticker, another screen 121 opens that has the option to type in a new message in a text box 122 and save it to the display or to view the current ticker message so the user can alter it and then resave it in Steps 1.44C-1.44E.

Referring the FIG. 1.45 and Step 1.45, the next component in this embodiment, is a weather module which the user accesses by selecting tab 107(e). In one embodiment, this is an rss feed that presents the weather in a particular zip code on the display periodically, for example, every three minutes. In one embodiment, the weather screen 123 opens and covers the left side text area of the display in Step 1.45A. The user can view the current zip code or edit the zip code and put in a new one in the window 124 in Step 1.45B. The weather module can be turned off or on using tabs 125 and is up to the end user whether they want it enabled in Step 1.45C. In one embodiment, the weather displays the forecast for several days into the future in Step 1.45D. The Time and Date display are also a part of the weather module.

Referring the FIG. 1.46 and Step 1.46, in this embodiment, the next component to the software is the ability to change the theme background image. The end user clicks on the Background tab 107(f) and then a selection appears with several still image choices 126 as well as some motion background choices 127 in Steps 1.46A-E. This allows the end user to change the look of the display easily as well as get back to the default theme quickly if necessary.

Referring the FIGS. 1.47(a) and (b) (two examples provided) and Step 1.47, in this embodiment, another customizable feature (component) is the Side Bar where there is Side Text and Optional Running Banner Advertisements. When the user clicks on the Banner Ads Tab 107(g), the user can turn on or off the advertisements in Step 1.47A. In one embodiment, the text behind the ads fades out and then fades back in when the ads are done. In one embodiment, the end user picks different ads in a built in ad library that he or she wants to run through on the side region of the display. This feature was created because not all businesses sell and promote the same content even though they are all in the same industry.

Referring the FIG. 1.48 and Step 1.48, another component and custom feature of this embodiment is the Import Image Module which is opened by selecting tab 107(h) (see FIG. 1.4). This allows the end user to easily browse and upload their own images to play in the slideshow. This module can be turned on or off in Step 1.48A. In one embodiment, when the end user clicks on the Import Image Tab 107(h), an area 128 appears that has a browse image button in Steps 1.48B-E. There is essentially no limit on how many images can be uploaded into this module. Once an image is uploaded, the end user can see a list/thumbnails of all the uploaded custom images. These images can be deleted or changed at any time. The images can be uploaded as a .jpg, .png, or .gif, and are randomly chosen to appear on the display periodically, for example, every 2 minutes for duration of 15 seconds. In one embodiment, these images appear in the main presentation region of the display, in which case, the presentation playing in the background will pause (for example for the 15 second duration) and then resume playing after the custom image disappears. In one embodiment, to avoid the problem of the end user upload images of different sizes, regardless of their proportion to the display, the images are stretched to fill the region correctly.

As mentioned above, it should be appreciated that this description of the interface above is for one embodiment of the invention and other embodiments exist within the scope of the invention as set forth in the claims below.

What is claimed is:

1. A digital signage system comprising:
a client device associated with a display device and linked to a server through said worldwide network, and having a user input device, said client device being configured to perform the following functions:
receiving a signal from said server, said signal corresponding to signage;
displaying said signage based on said signal;
displaying a window to configure said signage, said window being displayed in front of said signage, said window providing inputs to select content and/or format of said signage;
transmitting a selection of said content and/or format to said server when said selection is entered by a user;
receiving an updated signal from said server corresponding to said signage modified according to said selection; and
displaying the modified signage while said window is displayed, thereby providing said user with near real-time feedback of changes made to said signage.

2. The system of claim 1, wherein said window has a smaller area than said signage, thereby allowing a portion of said signage to be viewed behind said window.

3. The system of claim 1, further comprising:
said server linked to a worldwide network and having a data store of client information relating to signage; and
said digital display device for displaying said signage;

4. The system of claim 1, wherein said signage is displayed on a monitor associated with said client device.

5. The system of claim 1, wherein said client device is integrated with said display device.

6. The system of claim 1, wherein said input includes a function for providing a link in client information associated with said server to a 3^{rd} party server.

7. The system of claim 6, wherein said 3^{rd} party server is a video hosting website

8. The system of claim 7, wherein said function includes entering preferences at said link.

9. The system of claim 7, wherein said video hosting website is YouTube.com

10. The system of claim 1, wherein said input includes a function for providing a link in client information associated with said server to a music hosting website

11. A graphical user interface (GUI) for causing the simultaneous display of signage and at least one editing window, said GUI being configured to perform the following steps:
(a) generating a display of signage;
(b) displaying a window to configure said signage, said window being displayed in front of said signage, said window providing inputs for a user to select content and/or format of said signage;
(c) receiving a selection of said content and/or format from said user; and
(d) displaying the modified signage immediately after said selection is transmitted, thereby providing said user with near real-time feedback of changes made to said signage.

12. The GUI of claim 11, wherein said window is a control panel having a plurality of tabs, each tab corresponding to a different form of content to be added or modified in said signage.

13. The GUI of claim 12, wherein at least one of said tabs corresponds to a 3rd party content server.

14. The GUI of claim 13, wherein said 3rd party content server is a video hosting website.

15. The GUI of claim 14, wherein said video hosting website is YouTube.com.

16. The GUI of claim 13, wherein said 3rd party content server is a music hosting website.

17. The GUI of claim 12, wherein step (b) comprises displaying said tabs in said control panel, and, once a user selects a tab, displaying an interface for said different form of content.

18. The GUI of claim 17, wherein said interface is displayed in place of said control panel.

19. The GUI of claim 17, wherein said interface is display beside or overlapping said control panel.

20. A method comprising:
(a) generating a display of signage from a signal received from a server;
(b) displaying a window to configure said signage, said window being in front of said signage such that said signage is visible behind said window, said window providing inputs for a user to select content and/or format of said signage;
(c) receiving a selection of said content and/or format from said user and transmitting said selection to said server; and
(d) displaying the modified signage from said server behind said window, thereby providing said user with near real-time feedback of changes made to said signage.
